(19) United States
(12) Patent Application Publication
(10) Pub. No.: US 2026/0085889 A1
(43) Pub. Date: Mar. 26, 2026

(54) CURING OVEN SYSTEM FOR BUILDING MATERIALS AND METHOD FOR OPERATING A CURING OVEN SYSTEM

(71) Applicant: BERND MÜNSTERMANN GMBH & CO. KG, Telgte (DE)

(72) Inventors: Christian HAUTKAPPE, HERNE (DE); Georg OSTER, IBBENBÜREN (DE)

(21) Appl. No.: 18/936,341

(22) Filed: Nov. 4, 2024

(30) Foreign Application Priority Data
Sep. 26, 2024 (EP) 24202753.0

(51) Int. Cl. F27B 9/24; C03C 23/00; F27B 9/30; F27D 99/00

(52) U.S. Cl. CPC F27B 9/243; F27B 9/3005; F27D 99/0006; F27D 99/0033; C03C 23/007

(57) ABSTRACT

A curing oven system for drying and/or curing building materials. The curing over system has at least one curing oven configured to be heated by at least one heating device and having at least one curing oven zone for drying and/or curing the building materials, and at least one conveying device for transporting the building materials through the curing oven. The curing oven comprises at least one electrical heating device and may also include a non-electrical heating device. Also a method for operation such a curing oven.

### CROSS-REFERENCES TO RELATED APPLICATIONS

This application claims the benefit of European Patent Application Number 24202753.0 filed on Sep. 26, 2024, the entire disclosure of which is incorporated herein by way of reference.

### FIELD OF THE INVENTION

The invention relates to a curing oven system and to a method for operating a curing oven system.

### BACKGROUND OF THE INVENTION

Curing oven systems, such as in particular those described here, are used in particular in the production of building materials. Specifically, these are usually building materials that have to undergo at least one drying or curing step during production. Instead of “building material,” the terms “material” and/or “product” can also be used here.

For example, plate-shaped materials are made from fibers or fibrous material, such as mineral wool, glass fiber, and the like. These materials are then typically bound with a binding agent, such as an adhesive. Typically, the material provided with the binding agent is heated in a so-called curing oven in order to cure and/or dry the binding agent.

In order to enable the drying effect or the curing, the interior of the curing oven in particular must be heated. At least one heating device is provided for this purpose. It is known to heat the heating device by the combustion of gas.

However, disadvantages occur in doing so. For one, gas as an energy source is not always available in unlimited or at least sufficient quantities at a favorable price. Also, there are typically vapors that result from the building materials to be produced. In connection with an open fire in the oven, there is a risk of unwanted ignition or even explosion if, for example, the oven atmosphere cannot be adequately controlled.

### SUMMARY OF THE INVENTION

It is therefore an object of the invention to eliminate the described disadvantages. In particular, the heating is to be made less dependent on existing energy sources. Risks during operation are also to be reduced as far as possible.

The described object may be achieved in particular by a curing oven system having the features of one or more embodiments described herein. This is a curing oven for building materials, in particular building materials bound by a binding agent. The curing oven system is provided in particular for drying and/or curing building materials bound by a binding agent, in particular building materials containing mineral wool. The building materials can also be referred to as material and/or products. The curing oven system has at least one curing oven that can be heated with at least one heating device for curing the building material. The curing oven can have at least one curing oven zone, preferably a plurality of curing oven zones. In addition, at least one conveyor means is provided for transporting the building material through the curing oven. The curing oven system is characterized by the fact that the at least one curing oven, in particular at least one curing oven zone, has at least one electric heating device. An electric heating device, in particular at least one curing oven zone, can be operated with electric power. Electric power is readily available on a large scale. In particular, the electric power can also be provided from renewable sources, preferably photovoltaic and/or wind power. In particular, electric heating ensures safe and readily controllable operation. Fossil fuels can also be saved in this way.

Preferably, a plurality of heating devices are provided. In this way, alternative or combined heating can take place. Multiple heating devices can be operated together to increase the overall output or to reduce the output per heating device. Greater security against failure can also be achieved.

In particular, the curing oven exclusively has electric heating devices. Preferably, the curing oven is at least substantially completely electrically heatable. This enables operation with an easily controllable and/or safe energy supply. Open flames can thus be avoided.

In particular, the electric heating device has at least one electric heating coil, preferably a plurality of electric heating coils. By combining multiple heating coils, a higher output can be achieved than with single coils. This can also increase reliability against failure.

In particular, a non-electric heating device is provided, in particular a gas heating device. The non-electric heating device is preferably provided in addition to the electric heating device. This enables supplementary or alternative operation with different energy sources.

The at least one non-electric heating device preferably operates by combustion of at least one combustible material. Gas and/or wood and/or coal and/or hydrogen are also preferably provided as combustible materials. These energy sources are generally easy to store and/or warehouse. This allows a base load and/or supplementary operation to be achieved.

In particular, the at least one heating device has at least one heating element, with the at least one heating device having in particular a plurality of heating elements. A plurality of heating elements, preferably all heating elements of a heating device, can preferably have the same heating mode. This allows different combinations to be used for heating.

At least one conveyor belt is preferably provided as a means of conveying the material and/or product. Further preferably, multiple conveyor belts are provided, these being in particular arranged parallel to one another. The combination of conveyor belts can ensure a specific conveying of the material and/or product to be achieved.

In particular, at least one blower, preferably at least one fan, is provided for feeding a heated gas, in particular air, into the curing oven. Preferably, the at least one heating device is provided to heat the gas. In this way the curing oven is heated.

The object described above may also be achieved by a method having the features of one or more embodiments described herein for operating a curing oven system, in particular a curing oven system according to the above descriptions. The curing oven system has at least one curing oven with which at least one building material, in particular building material bound by a binding agent, is cured and/or dried. The building material is preferably transported through the curing oven by means of a conveyor means, the curing oven being heated by at least one heating device. The method is characterized by the fact that the curing oven is heated electrically by means of at least one heating device. An electric heating device can be operated with electric current. Electric power is readily available on a large scale. In particular, the electric power can also be provided from renewable sources, preferably photovoltaic and/or wind power. In particular, electric heating ensures safe and readily controllable operation.

In particular, the curing oven is heated completely electrically. In particular, purely electric operation ensures safe operation using only electric power.

The curing oven is preferably at least partially heated non-electrically and/or can be at least partially heated non-electrically. This can make it possible to combine different types of heating.

Preferably, the heating devices, and/or multiple heating elements of a heating device, are operated independently of one another, or can preferably be operated independently of one another. Security against failure can be achieved in this way. Loads on the individual heating devices can also be reduced.

The building material and/or the material is transported through the curing oven in particular as a flat and/or web-shaped material. The shape is therefore particularly suitable for this type of treatment.

Arrangements of heating devices and/or heating coils outside the actual heating zones and/or curing ovens are also conceivable. This can be provided for further processing steps. For example, this can be used for drying purposes or for pre-and/or post-treatment of the materials. External air circulation units and/or fans can also be provided outside the actual curing ovens and/or heating zones.

### BRIEF DESCRIPTION OF THE DRAWINGS

Preferred exemplary embodiments of the invention are described in more detail below with reference to the figures in the drawing. The drawing shows:

FIG. 1 a side view of a curing oven system with electric operation,

FIG. 2 a perspective view of the curing oven system according to FIG. 1,

FIG. 3 a side view of a curing oven system with electric operation and gas operation,

FIG. 4 a perspective view of the curing oven system of FIG. 3,

FIG. 5 a schematic drawing of the operation of the curing oven system of FIGS. 1 and 2, and

FIG. 6 a schematic drawing of the operation of the curing oven system of FIGS. 3 and 4.

### DETAILED DESCRIPTION OF THE PREFERRED EMBODIMENTS

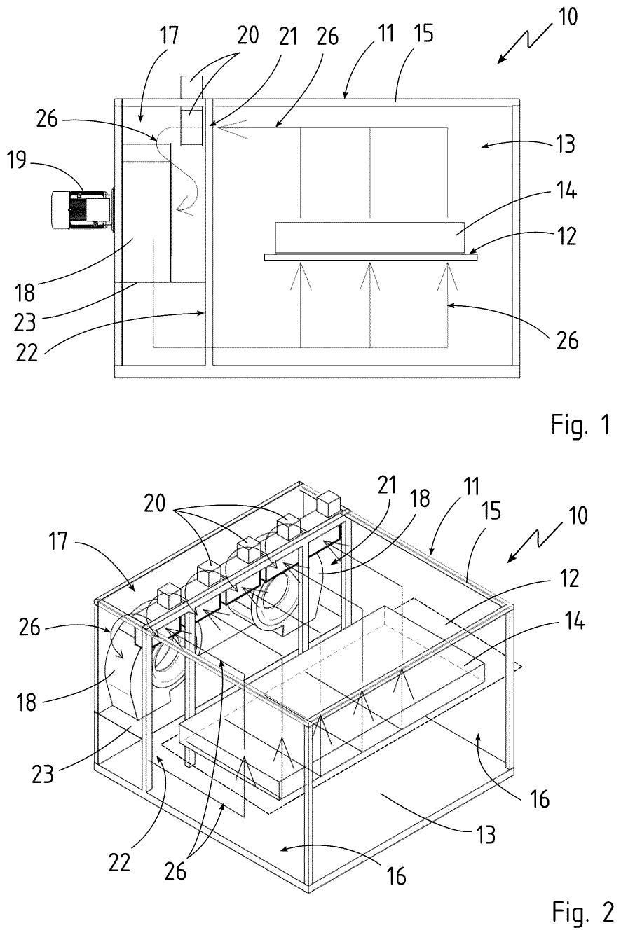

FIG. 1 shows a curing oven system 10 in a side sectional view. FIG. 2 shows a perspective representation of this curing oven system 10.

Here, the components of the curing oven system 10 are shown in the figures. One is a curing oven 11 and the other is a conveyor belt 12. The conveyor belt 12, as part of the curing oven system 10, runs through an interior 13 of the curing oven 11 shown here. Depending on the design of the curing oven system 10, the same conveyor belt 12 can also pass through a plurality of curing ovens or other components one after the other.

The conveyor belt 12 is used to transport a building material or a product, in particular as material 14, in particular through the at least one curing oven 11. A plurality of conveyor belts 12 or conveyor belts separated by sections or other transportation devices can also be provided for this purpose.

The curing oven 11 has a housing 15. In particular, the housing 15 encloses the interior 13. In order to be able to transport the product or material 14 into and out of the curing oven 11 by means of the conveyor belt 12, the curing oven has two openings 16. These openings 16 are arranged in particular opposite each other for this purpose. The conveyor belt 12 runs through these two openings 16 and thus at the same time also through the interior 13 of the curing oven 11. In this way, the product or material 14 can be transported through the curing oven 11.

In this case, the curing oven 11 has an air recirculation chamber 17. The air recirculation chamber 17 makes it possible to ensure an air flow through the interior 13 of the curing oven 11. In the present case, blowers or fans 18 are provided for this purpose. These are driven by drives 19. For example, the drives 19 can preferably be electric drives, such as, in particular, electric motors.

The fans 18 ensure a circulating air flow 26 in the interior 13 by suctioning in the upper region of the curing oven 11 and feeding in the lower region of the curing oven 11. The air flow 26 is outlined here with arrows in the figures, for illustration purposes. The air flow 26 is thus realized as a circulating air flow. The air flow can also be provided in the opposite direction. The air flow 26 then runs in the opposite direction to the arrows, so to speak. For this purpose, the suctioning in can take place in the lower region of the curing oven 11 and the feeding in can take place in the upper region of the curing oven 11.

In the exemplary embodiment of FIG. 1 and FIG. 2, electric heating coils 20 are also provided. Here, these are arranged in the region of the air recirculation chamber 17. In this case, the heating coils 20 are situated in the upper region of the air recirculation chamber 17.

The air or gas mixture suctioned in from the top of the interior 13 of the curing oven 11 is heated via the at least one electric heating coil 20. In addition, the air is conveyed into the lower region of the air recirculation chamber 17 via the fans 18. There it re-enters the interior 13 of the curing oven 11.

Accordingly, an upper air recirculation opening 21 is provided to connect the interior 13 with the air recirculation chamber 17. A lower air recirculation opening 22 is used here to return the air or gases to the interior 13. In order to be able to accordingly create an air flow by means of the at least one fan 18, a separating wall 23 is provided here within the air recirculation chamber 17. This wall acts to guide the air flow in a defined manner.

The air suctioned from the interior 13, or the gases contained therein, are accordingly suctioned in over the electric heating coils 20. In this way they are heated. By means of the at least one fan 18, further transportation back into the interior 13 then takes place. As the heated gases contact the product or material 14 from below the conveyor belt 12, the material 14 is cured or dried. If the air flow is directed differently, the air flow 26 can of course also contact the material from other directions. For example, if the air flow is reversed compared to the drawings, the air can contact the material from above.

For this purpose, the conveyor belt 12 is typically provided with perforations or openings so that the gases can pass through the conveyor belt 12. The material 14, in particular a building material, preferably also has a porous structure. As a result, the heated gas can at least partially pass through this material 14. This achieves a particularly good drying and/or curing effect.

By operating the curing oven 11 using electric heating coils 20, improved controllability during operation is achieved. The heat output can be regulated quickly and/or precisely. In addition, through electric operation renewable energy, such as solar power and/or wind energy, can be used in a particularly advantageous way. These are readily available during the day, for example. This means that the availability of electric energy can be utilized particularly well.

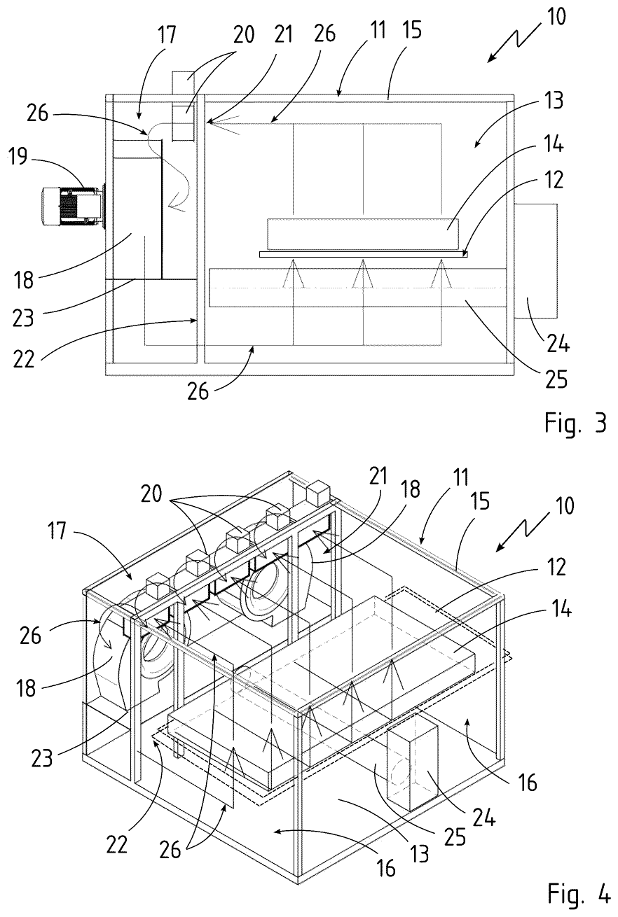

FIGS. 3 and 4 show a further exemplary embodiment of the invention.

The mode of operation here corresponds substantially to the exemplary embodiment of FIGS. 1 and 2. Air recirculation with electric heating is likewise provided in the curing oven 11. The corresponding components are marked identically as described above.

However, in addition to the electric heating operation of the first exemplary embodiment of FIGS. 1 and 2, a further heat source is also provided. In this exemplary embodiment, a gas burner 24 is also provided.

In this example, this gas burner 24 is arranged outside the housing 15. A heating pipe 25 is installed here to transport the heat into the interior 13 of the curing oven 11. This heating pipe 25 runs underneath the conveyor belt 12. In this way, the heated gas or the heated air can accordingly heat the material 14 from below.

A combination of different heating systems can make sense in order to use different energy sources, such as, in this case, electric energy on the one hand and chemical energy from gas on the other hand. Alternative operation, as well as combined operation using different heat sources, is therefore conceivable.

For example, the at least one gas burner 24 can be operated as a base load heater. The temperature can be quickly readjusted using the electric heating coil 20. In the converse case, corresponding operation can also be provided. If large amounts of electric energy are available, primary operation can be carried out using the electric heating coil 20, i.e., as a base load heater. The gas burner 24 can then be switched on if appropriate, if an additional heat source is required.

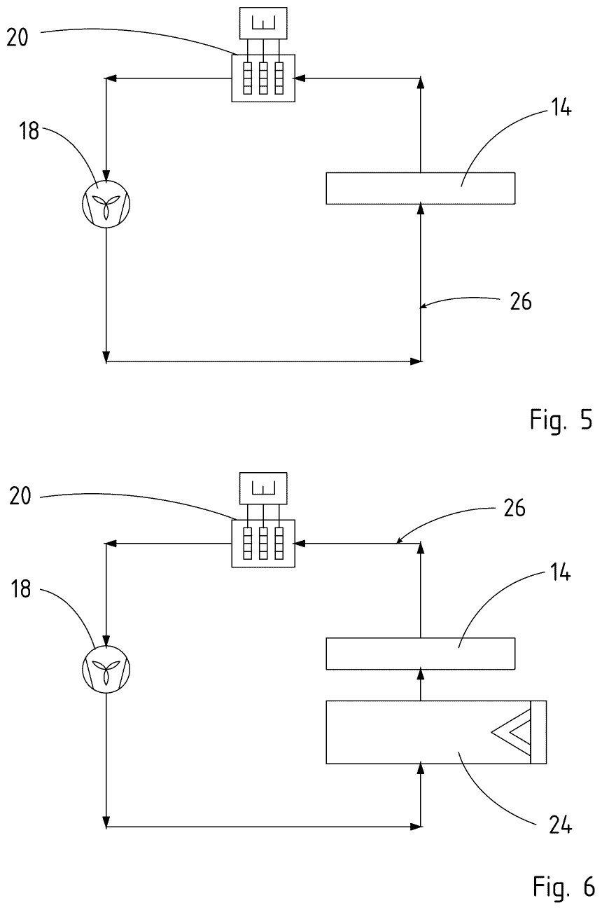

FIGS. 5 and 6 show schematic drawings of the functioning of the two heating modes.

FIG. 5 shows the heating mode with only electric heating coils 20, according to the exemplary embodiment of FIGS. 1 and 2. Here the air recirculation operation is shown by the circulating arrows. The electric heating coil 20 with the fan 18 and the material 14 are shown.

Accordingly, FIG. 6 also shows the gas burner 24 for operation with a combustion oven. In the drawing, this burner is situated below the material 14. In this way, the rising hot air or hot gas can be supplied directly from below the material 14. The air recirculation operation also ensures continuous mixing and supply of hot air here.

Overall, air recirculation mode can also be used to remove outgassing materials from the oven. This can ensure that explosive mixtures are effectively avoided in the interior 13 of the curing oven 11. Fresh air can be supplied accordingly to reduce any possible explosive concentrations of combustible gases.

The arrangement of the system components here is to be understood as an example. Thus, parts of the air guiding system can also be arranged outside the actual curing oven 13 or heating zones. For example, the fans 18 and/or heating devices or heating coils can be arranged outside the actual oven 13. In such a case, air ducts may be required.

A corresponding method for operating a curing oven system is also possible on the basis of the described exemplary embodiments.

Here, an electric heating of the curing oven 13 is provided. For this purpose, in particular the electric heating coils 20 are provided. Additional non-electric heating is possible. For this purpose, in particular gas heaters 24 can be used.

Operation of the individual heating elements or heating devices can be done in coupled fashion or independent of each other. In this way, the electric heating coils 20 can be operated independently of each other, if several heating coils 20 are present. Combined and/or independent operation of the electric heating coil 20 and the gas heating device 24 is also possible. In this way it is possible to exploit the advantages of the different heating modes.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 Curing oven system
11 Curing oven
12 Conveyor belt
13 Interior space
14 Material
15 Housing
16 Opening
17 Air recirculation chamber
18 Fan
19 Drive
20 Electric heating coil
21 Air recirculation opening
22 Air recirculation opening
23 Separating wall
24 Gas burner
25 Heating pipe
26 Air flow

1. A curing oven system for drying and/or curing building materials, the curing over system comprising:
at least one curing oven configured to be heated by at least one heating device and having at least one curing oven zone for drying and/or curing the building materials, and
at least one conveying means for transporting the building materials through the at least one curing oven, wherein the at least one curing oven comprises at least one electrical heating device.

2. The curing oven system according to claim 1, wherein a plurality of heating devices are provided.

3. The curing oven system according to claim 1, wherein the at least one curing oven comprises exclusively electrical heating devices, or
wherein the at least one curing oven is configured to be heated at least substantially completely electrically, or
both.

4. The curing oven system according to claim 1, wherein the at least one electrical heating device comprises at least one electrical heating coil.

5. The curing oven system according to claim 1, further comprising:
at least one non-electric heating device.

6. The curing oven system according to claim 5, wherein the at least one non-electric heating device operates with combustion of at least one combustible substance.

7. The curing oven system according to claim 1, wherein the at least one electric heating device comprises at least one heating element.

8. The curing oven system according to claim 1, wherein at least one conveyor belt is provided as the at least one conveying means.

9. The curing oven system according to claim 1, wherein a plurality of conveyor belts are provided as the at least one conveying means, wherein the conveyor belts are parallel to one another.

10. The curing oven system according to claim 1 further comprising:
at least one blower for feeding a heated gas into the at least one curing oven.

11. The curing oven system according to claim 10, wherein the at least one electrical heating device is configured to heat a gas to provide the heated gas.

12. A method for operating a curing oven system, the curing oven system comprising at least one curing oven with at least one curing oven zone, with which at least one building material is cured and/or dried, the building material being transported through the curing oven with a conveying means, wherein the method comprises:
electrically heating the at least one curing oven with at least one heating device.

13. The method according to claim 12, wherein the at least one curing oven is completely electrically heated.

14. The method according to claim 12, wherein the at least one curing oven is heated and/or is configured to be heated, at least partially, non-electrically.

15. The method according to claim 12, wherein the at least one heating device comprises a plurality of heating elements that are configured to be operated independently of one another.

16. The method according to claim 12, wherein the building material is transported through the at least one curing oven as a flat and/or web-shaped material.
